(19) United States
(12) Patent Application Publication
(10) Pub. No.: US 2010/0174624 A1
(43) Pub. Date: Jul. 8, 2010

(54) SYSTEMS AND METHODS FOR FINANCING HIGH-VALUE ITEMS

(76) Inventors: Gabriel G. Nasser, Dubai (AE); Yusuf Nonoo, Manama (BH)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/624,957

(22) Filed: Nov. 24, 2009

Related U.S. Application Data
(63) Continuation-in-part of application No. 11/994,153, filed on Jul. 29, 2008.

(30) Foreign Application Priority Data
Sep. 29, 2005 (GB) 0519848.6

(51) Int. Cl. G06Q 40/00; G06Q 10/00; H04Q 5/22

(52) U.S. Cl. 705/28; 705/38; 340/10.1

(57) ABSTRACT

Methods and supporting systems for inventory financing and tracking receives information from potential borrowers, potential lenders, and from inventory tracking sub-systems. The information includes information regarding items in inventory, information about the potential borrowers, information about potential lenders and information identifying the items in inventory held by the borrowers. Potential borrowers are matched with potential lenders, thus identifying lenders to provide financing to borrowers, and provides the lenders with access to the inventory information.

### CROSS-REFERENCE TO RELATED APPLICATIONS

This application is a continuation-in-part of currently pending U.S. patent application Ser. No. 11/994,153, filed Jul. 29, 2008, which claims priority to PCT patent application serial number PCT/GB2006/003526, filed Sep. 22, 2006, which claims priority to British Patent application serial number 0519848.6, filed Sep. 29, 2005.

### FIELD OF THE INVENTION

The present invention relates to the financing of inventory, and more specifically, providing an lending marketplace for potential borrowers and lenders as well as providing item-specific inventory information to the lenders.

### BACKGROUND TO THE INVENTION

In a typical supply chain an item is moved from the possession of one party to the next party in the chain, and the ownership of that item is transferred between those parties at the same time. For example, in a retail supply chain a retailer may buy a retail item from a wholesaler or manufacturer and then subsequently sell this item to a customer. However, it can be seen in this scenario that the retailer takes a financial risk when trading in this way as their money will be tied up in the item while it remains unsold, and in some cases (e.g., commodities, jewellery, etc.) market price fluctuations may mean that they are not able to sell the item for a price equal to or higher than the price they paid for it.

Recent financing solutions have made it possible for a retailer to pass the financial risk to a third party by introducing a system whereby a retailer may borrow a retail item from a lender and fix the price they pay the lender for that item at the time it is sold to a customer. Thus, the lender may make a profit on the item when the price is paid by the borrower but also accepts the risk that they make a loss if the price paid by the borrower is less than the price the lender paid for that item. In payment for accepting the risk on behalf of the retailer, the lender can seek a fee from the retailer for each item borrowed in addition to the price paid by the retailer for the item. Such a fee is generally in the form of an interest charge based on the value of the item that is payable over the period the retailer is in possession of the borrowed item.

Because these risks to both the lenders and the borrowers, the ability of the borrower to secure financing and of the lender to maintain visibility of the inventory securing his loan(s), matching borrowers with lenders is difficult, and the cost of lending is often high.

### SUMMARY OF THE INVENTION

To address the challenges described above, various embodiments of the invention allow retailers to secure financing for their inventory in an open marketplace format, thus avoiding traditional lenders (e.g., banks) while providing the lenders with real-time, transparent access to the status and/or location of the specific items of inventory he has financed. To achieve this, an RFID tracking device is securely affixed to the item being financed that the lender may view data transmitted from the device to monitor the item and to be assured of its location and security. The data transmitted by the RFID tracking device may be unique to that item and may be associated with properties of the item such as weight, value, etc. If the borrowed item is sold by the borrower to a third party, the borrower may pay the lender a capital charge for that item derived from the value of that item at the time of sale, pay off the loan, or have the loan secured by other items.

Thus, according to a first aspect of the present invention, a system for financing and tracking inventory includes a communications server, a data storage module, and an application server. The communications server receives information from potential borrowers, potential lenders, and from inventory tracking sub-systems. The information received from the potential borrowers includes information regarding the items in inventory and information about the potential borrowers. The information received from the potential lenders includes information regarding the potential lenders. The information received from the inventory tracking sub-systems includes information identifying the items in inventory held by the borrowers. The data storage module stores the received information and provides it to the application server for processing and/or analysis. The application server includes computer-executable programs stored on a computer readable medium. The programs include instructions for matching potential borrowers with potential lenders, thus identifying one or more selected lenders to provide financing to one or more selected borrowers. The instructions also provide the selected lenders with electronic access, via the communications server, to the inventory information.

In some implementations, the system may also include inventory tracking subsystems. These sub-systems may include RFID components (tags, readers, application software, etc.) and be used to track and trace items of inventory using securely affixed and, in some cases, tamper evident, tags. Some (or all) of the system components may be located at, operated by, hosted by and/or owned by an entity other than a borrower or seller, thus providing an on-line lending marketplace tied to specific inventory items. In some cases, the inventory tracking sub-systems may be located at the individual retail locations and hosted service receives inventory information from each of the locations over a communications network, such as the Internet.

The RFID tracking device used in the present invention may be any of a variety of commercially available devices. The lender may further increase the level of assurance that the borrowed item is accounted for through the use of a tamper-proof or tamper-resistant RFID tracking device. Such devices are known in the art and disclosed in published PCT patent application no. WO2005062246, the entire disclosure of which is incorporated herein by reference.

In another aspect, a method of financing inventory includes receiving, at a communications server and via an electronic network, requests from potential borrowers wishing to secure financing for items in inventory and potential lenders wishing to provide financing for items in inventory. The requests from potential borrowers includes data describing the items in inventory held by the potential borrower and data describing the potential borrower. The requests from potential lenders includes data describing potential borrower. The communications server also receives information uniquely identifying one or more of the items in inventory being held by the borrower. The received information is stored in a data storage device. The potential borrowers are matched with potential lenders based on the stored information, thus selecting lenders to provide financing selected borrowers for certain items held in inventory by the selected borrowers. The selected lenders are provided with electronic access, via the communications server and the electronic network, to inventory information related to the selected items in inventory that they are financing.

Preferably, when more than one item is borrowed the borrower will periodically perform an inventory. The inventory may be taken by the remote scanning of all borrowed items affixed with RFID tracking devices contained in the borrower's retail premises so that data transmitted by the devices can be recognized and recorded. Subsequent inventories can be taken to reduce any significant errors (e.g. missed items), and a retail premises may be divided into ‘zones’ by floor area, shelf etc. to ensure that all sections of the premises are sufficiently monitored or to produce a more detailed inventory. This inventory information can be reported to the lender so that they have details of and evidence of the borrowed items in the possession of the borrower.

In a similar way, sales information may be recorded by the borrower through RFID tracking device scanning at the point of sale such that the data transmitted by the RFID tracking device of a sold item may be recognized and reported to the lender. In this way, the lender may have details of and evidence of the borrowed items sold by the borrower.

To further enhance the lender's assurance of the security of the borrowed items, the borrower's inventory and sales recording procedures may be monitored and inspected by the lender (or an agent of the lender) to ensure compliance with the agreed processes.

The inventory and sales information reported by the borrower may be used by the lender to procure insurance against loss of the borrowed item, and to claim against this insurance should such a loss occur. This information can be used to further reduce the cost of the insurance to the lender as the risk to the insurer, which may be a sole insurer or a network of insurers, is reduced.

It will be understood that in the method of the present invention a borrowed item is the property of the lender but that an item may be the property of the borrower before the borrowing commences. In such a case the lender will buy the item from the borrower before that item is borrowed.

### BRIEF DESCRIPTION OF THE DRAWINGS

An embodiment of the present invention will now be described, by way of example, with reference to the accompanying drawings, in which:

FIG. 1 is a diagram showing an overview of an item tracking system;

FIGS. 2a and 2b show typical forms of an RFID tracking device;

FIG. 3 is an activity diagram showing the sequence of events when an item is removed from the lender's wholesale premises and taken to the borrower's retail premises;

FIGS. 4a and 4b show overviews of systems for the creation and maintenance of inventories;

FIG. 5 is a diagram showing an overview of a system for recording the sale of an item;

FIG. 6 is an activity diagram showing the sequence of events when an item is sold;

FIG. 7 is a diagram showing an overview of a system for automatically procuring, monitoring and claiming against insurance from a network of insurance providers;

FIG. 8 is a diagram showing an overview of a system for automatically arranging, monitoring and paying for the borrowing of items through a network of lending providers; and

FIG. 9 is an overview diagram showing security cameras integrated into an item tracking system.

### DETAILED DESCRIPTION; FURTHER OPTIONS AND PREFERENCES

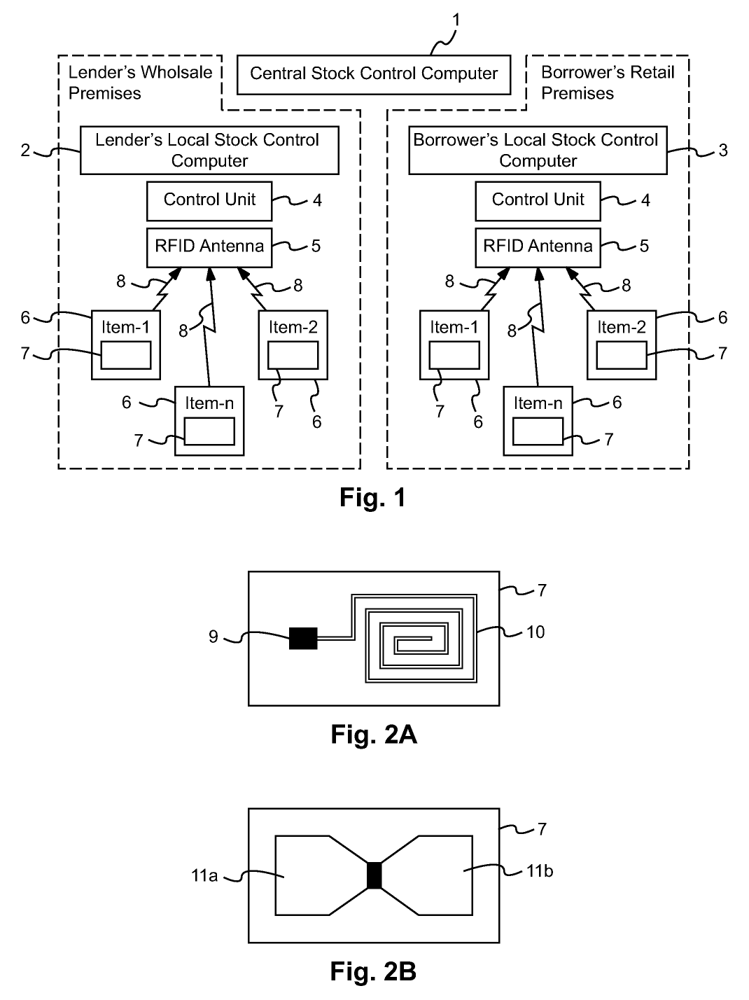

An overview of an item tracking system that can facilitate the use of the method of the present invention will be described herein with reference to FIGS. 1 and 2. While the description below uses a retail establishment as an example, the systems and techniques described herein are applicable to any premises at or in which one entity is holding goods for another party that has a vested (e.g., financial and/or ownership) interest in the goods.

FIG. 1 shows the main components of this item tracking system. A lender's central stock control computer 1 communicates, by cable, via a network, wirelessly, the internet etc., with local stock control computers of the lender's wholesale premises 2 and the borrower's retail premises 3. The lender's local stock control computer 2 communicates, via the control unit 4, with an RFID antenna 5 which detects the presence, or otherwise, of RFID tracking devices 7 affixed to items 6 which together form the stock of the wholesale premises. Data 8 transmitted by the RFID tracking devices 7 contains information about the detected items which is used by the lender's wholesale premises local stock control computer 2 to update and maintain inventory information for the wholesale premises. This inventory information is then communicated to the lender's central stock control computer 1.

The system of the borrower's retail premises is similar in function. The local stock control computer 3 communicates with the RFID antenna 5 of the retail premises, via the control unit 4, to record information about the detected items 6 affixed with RFID tracking devices 7 currently inside the retail premises. This information is used by the local stock control computer 3 to update and maintain inventory information for the retail premises. The inventory information is then communicated to the lender's central stock control computer 1.

Alternatively, the lender's central stock control computer 1 may interrogate the borrower's local stock control computer 3 at any time to verify the location or status of any borrowed item, or such information may periodically be automatically sent by the borrower's local stock control computer 3 to the lender's central stock control computer.

It will be understood that the above system may be adapted to a system of more than one lender's wholesale premises or more than one borrower's retail premises. In addition, it is clear that one wholesale premises or one retail premises may contain more than one RFID antenna for detecting RFID tracking devices, for example where large metallic structures obstruct the progress of a single radio signal to particular areas of a wholesale premises or retail premises, or where it is desirable that a wholesale premises or retail premises be divided into ‘zones’, i.e. by floor area, shelf, building etc.

The RFID tracking device 7 of the above system can be any of a number of commercially available RFID tracking device devices. These devices transmit stored data through radio frequency transmission when the devices are appropriately activated. In addition, RFID tracking devices can receive information and either store or act on that information. An RFID tracking device is composed of an integrated circuit connected to one (or more) antenna(s), which may be in one of two forms, as shown in FIG. 2. FIG. 2a shows an RFID tracking device 7 with an inductive loop antenna 10 connected to an integrated circuit 9, while FIG. 2b shows an RFID tracking device 7 with an antenna comprising two capacitive plates 11a, 11b.

Further developments in the technology of RFID tracking devices means that they may be rendered “tamper-proof” or “tamper-evident” by, for example, being formed with a line of weakness, such as a line of perforations, extending across at least a portion of the antenna or between the antenna and the integrated circuit. When the device is broken along the line of weakness the antenna of the device is rendered unable to communicate with the RFID interrogator device. The RFID interrogator device, such as the RFID antenna 5 of the system described above, can then activate an alarm or send an alert to a central computer, for example, when a device is tampered with.

In a preferred embodiment of the method of the present invention, the borrower selects a number of items 6 (items 1 to n) to borrow from the lender. These items 6 are affixed with RFID tracking devices 7 so that their position may be tracked. The RFID tracking devices may be, for example, in the form of a tag, label, container etc. and may be either fixed directly to the item, to an object fixed to the item, or to a vessel containing the item etc.

The lender may then record in either the central stock control computer 1 or a local wholesale premises stock control computer 2 the details of the items to be borrowed. Such details may include the type of item, the number of items, the weight, the date the borrowing will commence, and an agreed borrowing interest rate, for example.

The items may either be the property of the lender or the property of the borrower before the borrowing commences.

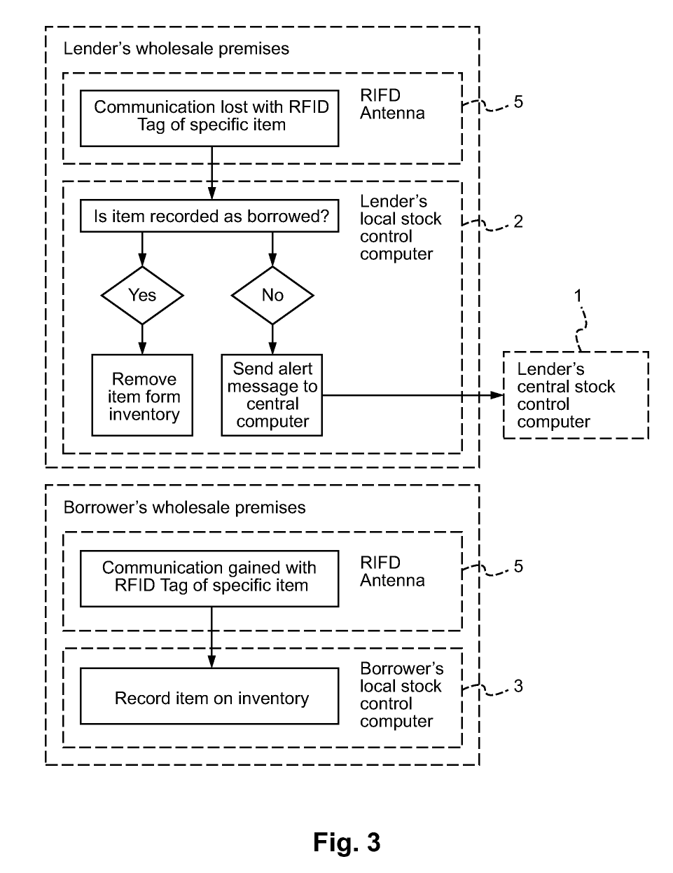

In the former case, when the borrower, or their representative, collects the agreed items from a lender's wholesale premises the method of FIG. 3 is commenced. As the borrowed items are removed from the wholesale premises the RFID antenna 5 loses radio frequency contact with the RFID tracking devices of those items. The RFID antenna 5 passes details of the codes of those RFID tracking devices via the control unit 4 (not shown) to the local stock control computer 2. The local stock control computer checks those codes with its records: if the item is listed as being borrowed the item is duly removed from the wholesale premises inventory; if, however, the item is not listed as being borrowed, an alert message is sent to the central stock control computer. In addition, in the latter case, an alarm may be sounded or alternative means of registering the unauthorized removal of items may be employed.

When the borrowed items are delivered to the borrower's retail premises the RFID antenna 5 of the retail outlet detects the presence of the RFID tracking devices affixed to the items and passes details of the data transmitted by these RFID tracking devices via the control unit 4 to the local stock control computer 3. The local stock control computer 3 then duly records details of these items on the retail outlet inventory.

Alternatively, when the borrowed property is initially the property of the borrower the lender will purchase the property from the borrower either with cash or by provision of other goods with equivalent value before the borrowing commences. In this case the RFID tracking devices may be affixed to the borrowed items in the borrower's retail outlet or alternative premises of the borrower either before or after the borrowing commences. In the same way as described above, the RFID antenna 5 of the retail outlet detects the presence of the RFID tracking devices affixed to the items and passes details of the data transmitted by these RFID tracking devices via the control unit 4 to the local stock control computer 3. The local stock control computer 3 can then record details of these items on the retail outlet inventory.

In other instances, the borrower may wish to retain title to the property, but still require capital in order to finance her inventory. For example, a jeweler may want to purchase various pieces of gold jewellery, but lack the necessary funds. One well-known, conventional solution to this problem is to approach a bank for a loan. The bank lends capital to the jeweler, who typically secures the loan using the jewellery. The jeweler agrees to pay off the loan over time, assuming that during the lifetime of the loan she will sell enough inventory to pay off the loan. While well understood, such an approach does not work well for certain high-value items, especially during times of economic uncertainty. Banks, usually conservative in nature, become even less willing to loan money to small retailers when market conditions are not favorable, even when such conditions have little or no relevance to the actual items being financed.

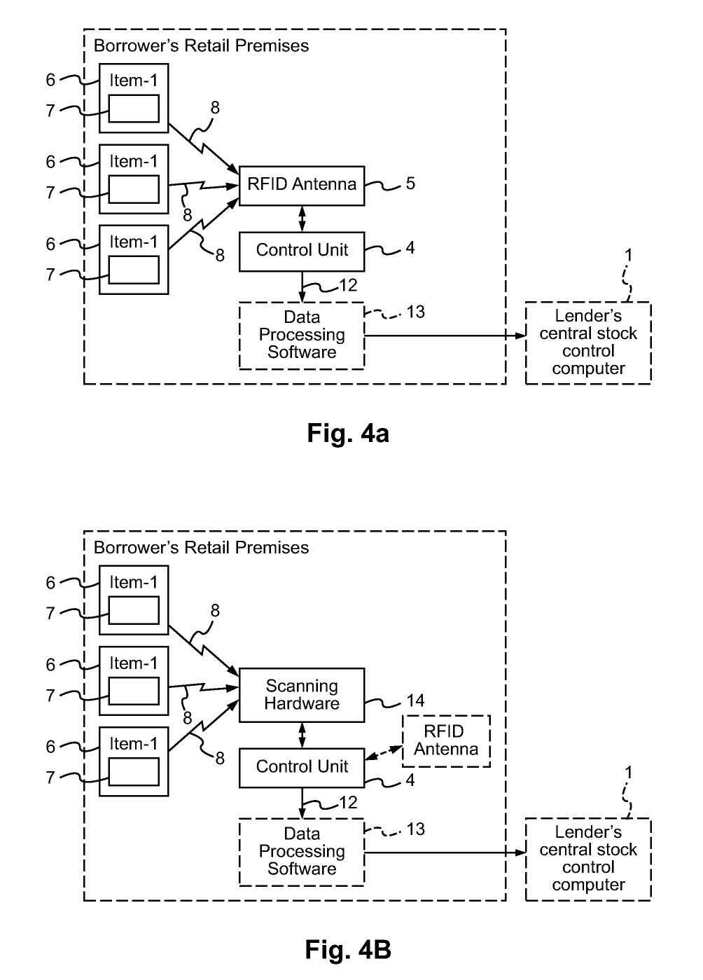

Periodically during the period of the loan the borrower may perform an inventory of the items. This inventory can be carried out by an automatic method as described below with reference to FIG. 4a. RFID code information 8 transmitted from the RFID tracking devices affixed to the borrowed items 6 present in the borrower's retail premises is received by the RFID antenna 5 and passed to the control unit 4. The control unit 4 passes this stock inventory information to the central stock control computer 1 via an electronic communication channel 12. This communication channel can be via cables, radio frequency, local network, the internet etc. Before the control unit 4 transmits the inventory information to the central stock control computer 1, it may be processed or formatted by data processing software 13.

Alternatively, the inventory may be carried by a manual method by using commonly available scanning hardware 14 to register the presence of an RFID tracking device at close proximity, as shown in FIG. 4b. This scanning hardware may be directly connected to the borrower's local stock control computer 3 so that an inventory list can be compiled locally, and possibly processed or formatted by data processing software 13, before being sent to the central stock control computer 1 via an electronic communication channel 12.

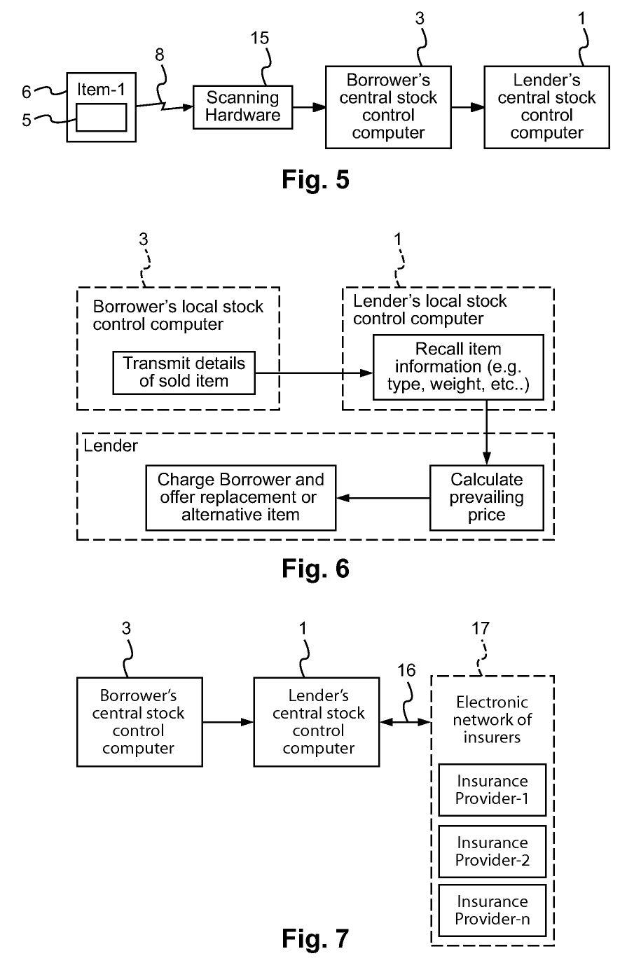

FIGS. 5 and 6 shows the method employed at the point of sale of an item 6 by the borrower. The RFID tracking device 7 of the item is scanned using commonly available scanning hardware 15 which receives and recognizes the data transmitted 8 by the RFID tracking device when the RFID tracking device is brought within range. The scanning hardware 15 sends details of the code of the RFID tracking device, via an electronic link, to the borrower's local stock control computer 3. Thus, the local stock control computer 3 determines which item the RFID tracking device 7 is affixed to and removes this item from the inventory.

In addition, the local stock control computer 3 sends details of the sold item to the lender's central stock control computer 1 at the point of sale, as shown in FIG. 6. The lender's central stock control computer 1 passes these details to the lender along with details held about the item such as e.g. weight, type, date borrowing commenced etc.

During the borrowing period the lender may calculate interest payable on each of the borrowed items on a daily basis in order to charge the borrower. The interest rate used for this calculation is that agreed with the borrower and that recorded in the central stock control computer 1. This interest rate may be fixed or may vary. In the case when the borrowed goods are gold jewellery items, the interest rate may be charged at an agreed rate above the gold LIBOR interest rate.

The lender may use the details of a sold item to determine a cost for that item based on the value of the item at the point of sale, calculated by a method agreed with the borrower, and charge this amount to the borrower. The lender may then offer to supply a replacement item or an alternative item to the borrower. In the case when the borrowed items are gold jewellery items the value of the item may be determined with reference to the London gold fix.

The processes of calculating an interest or cost charge to the borrower, or of offering to supply a replacement or alternative item to the borrower may be automated and communicated to the borrower via electronic communication between the lender's central stock control computer 1 and the borrower's local stock control computer 3.

In order to ensure the risk to the lender for loss and/or fraud is minimized, the lender may purchase insurance against loss or misrepresentation of borrowed items held at the borrower's premises through fire, theft, fidelity, terrorism or fraud. The inventory and sales information produced by the borrower may be used as evidence of the borrowed items held at the borrower's premises at the time of the loss.

Preferably, the insurance may be purchased, monitored and claimed against through automatic request and reporting by the lender's central stock control computer 1 of the item tracking system to an electronic network of 1 to n insurance providers 16, as shown in FIG. 7. The lender's central stock control computer 1 can send information 16 containing details of the borrowed items currently in the possession of the borrower (sales and inventory information), the prevailing value of the stock, and a status of the stock (stored in wholesale premises, displayed in retail premises, stolen, etc.), for example, to the electronic network of insurers 16. This information can be used by the electronic network of insurers 16 to, for example, determine a cost of insurance, modify a cost of insurance or begin a process of claiming for lost stock against an insurance policy held and/or filing a claim for fraud

The borrowing of items by a borrower as described above may be made by one lender or by a syndicate of two or more lenders. The lenders may preferably operate in a tiered arrangement of risk-evaluated lending, or lending on a pari passu basis to one or more borrowers. In the case that the lenders operate a tiered arrangement of risk-evaluated lending the interest rate offered to the borrower may be determined according to the level of risk the lenders evaluate for the borrower. In the case that the lenders operate on a pari passu basis all borrowers may be offered an equal interest rate, though this interest rate may vary with the predominant economic conditions.

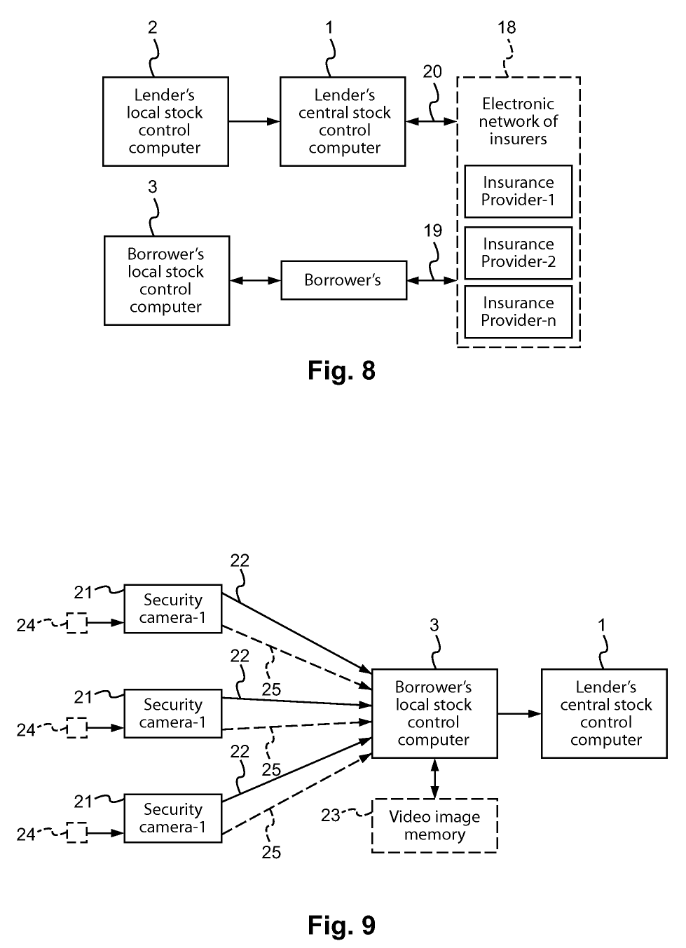

Preferably, the borrowing of items may be arranged, monitored and paid for through automatic request and reporting to an electronic network of lending providers 17, as illustrated in FIG. 8. The borrower can send information to the network of electronic lending providers 17 via an electronic communication channel 16 which may be cabled, wireless, the internet, or a local area network etc. This information can consist of the type of item to be borrowed, whether the borrower wishes to borrow items from the lender's stock or wishes the lender to buy the borrower's stock to be loaned back to him by the lender and the date borrowing should commence, for example. The electronic network of lending providers 17 can then determine an offer or a range of alternative offers for borrowing and can communicate this information to the borrower via the electronic communication channel 16. The borrower can indicate via the electronic communication channel 16 whether the offer is accepted (or which offer is accepted) or rejected. If the offer is accepted, the electronic network of lending providers 17 can confirm the contract with the borrower via the electronic communication channel 16 and can also send details of the contract to the lender's central stock control computer 1. The lender's central stock control computer 1 can then inform the lender's local stock control computer 2 of the agreed items to be borrowed along with information about the borrower and the date for borrowing to commence, etc. and can note these items as ‘borrowed’ in its inventory.

In the method described above, the borrower's local stock control computer may take the form of a Personal Computer connected to the internet or directly to the electronic network of lending providers in the event that the borrower does not already have the system of FIG. 1 installed in their retail premises.

In order to further reduce the level of risk to the lender, security cameras 21 (or other sensing and monitoring devices) may be integrated in to the item tracking system as shown in FIG. 9. The security cameras 21 may be located in the borrower's premises so as to provide adequate video coverage of the premises. The security cameras can then send analogue or digital video images 22 to the borrower's local stock control computer 3. In the case that the images are analogue they can be converted to a digital format by the borrower's local stock control computer 3, which may store a copy of these digital video images 22 in a video image memory 23, which can be integral with the borrower's local stock control computer 3 or remote from it, before transferring the video digital images 22 to the lender's central stock control computer. The lender can thus have a record of all activity in the borrower's premises which can be utilized in the event that a loss of items is discovered.

Further, the security cameras may be equipped with movement sensor devices 24 so that when movement in the premises is detected out of normal business hours, for example, an alert message 25 may be relayed to the borrower's local stock control computer 3 and/or the lender's central stock control computer 1.

In addition, embodiments of the present invention provide techniques and supporting systems for creating a “lending marketplace” in which specific inventory items are matched with potential lenders. Unlike existing loan marketplaces that match lenders and borrowers at the macro level (e.g., limited to a gross amount and basic terms), this approach allows lenders to select (or, in some cases, selects for lenders) specific articles of inventory and, by using the RFID-enabled inventory methods described above, allows the lender to maintain visibility of the particular articles securing his loan.

More specifically, a retailer of high-value goods identifies various items of inventory that she either currently stocks and needs to finance, or is wishing to stock. Separately, various investors (e.g., non-bank “lenders”) may have capital available to lend out to individuals and businesses. Like conventional loan-bidding and so-called “micro-lending” operations, lenders can be matched to borrowers based on funds needed, interests (e.g., jewellery, art, luxury automobiles, etc.) and terms (duration of loan, interest rates, etc.). Unlike these outfits, however, the retailer has specific, traceable inventory to which a particular lender, loan, and/or amount of capital can be allocated. Using the example above, a jeweler identifies specific pieces of jewellery and securely affixes an RFID tag to each article. Identification information about the article (e.g., make, model, price, style, source, cost etc.) is entered or captured, associated with the unique RFID tag number assigned to the tag, and the data is stored in a database. In a typical application, many jewelers utilize the inventory control and financing models described herein, and in some cases data from multiple retail locations, companies and geographic areas may be combined into a single database. In other cases, each retailer may maintain separate systems and databases.

The retailer (in this case the “borrower”) registers with the system one of many ways. In one instance in which the process is provided as a service by a third-party service provider, the borrowers may complete an application. The application may request, for example, information regarding the type of inventory typically held by the borrower, their recent sales activities, and/or background information about the company, its principals, and its employees. The application may also request the borrower to include credit history information, and details about the various security systems and protocols being used at the location(s). The borrower may proceed through a qualification process (e.g., they are either accepted into the marketplace or denied) or may receive a rating indicating a credit-worthiness or risk factor as calculated by the system. For example, a retailer specializing in diamonds that employs armed guards and sophisticated inventory control systems having no history of theft or loss may be rated as an “A” borrower, whereas a newly established retailer having no history and specializing in electronics may be rated as a “B” borrower. These ratings may, in some cases, be used to match borrowers to lenders, or influence the terms of the loan (e.g., interest rate, default provisions, monitoring requirements, etc.).

In some embodiments, the registration, qualification and/or rating process may be done manually (e.g., through a series of interviews) whereas in other instances the processes may be automated. For example, a borrower may use a computer, PDA, smart-phone, or other WAP-enabled device to access a web portal, at which the retailer enters some or all of the information described above. The information is received via a web server and stored in a database. An application server (or other processing device utilizing specially-designed software and/or hardware) then uses the data to rate the borrower and, in some cases, automatically match the borrower with one or more potential lenders.

Potential lenders may also access the system though one or more web portals, which may be the same portal used buy the borrower, or in some cases a different portal. The web portals may be accessible via a computer, mobile device, or any data delivery/presentation platform or device. Each web portal may be attributed to a single retailer, whereas other portals may provide access to a collection of related retailers (multiple locations of storefronts owned by a common entity) and still other portals may provide access to multiple, unrelated retailers. The lenders register with the system by providing basic contact information as well as certain financial information which may be used to confirm the financial stability of the lender. The lender uses the portal to enter various loan parameters (size of loan, term, desired interest rate, type of collateral, maximum number of borrowers, minimum borrow credit rating, security ratings of the premises, etc.) which are used to match the lender with one or more borrowers. Using the example above, a lender may have $25,000 to invest, hoping to achieve a 5% return over the next six months. To limit his risk exposure to any one particular retailer, he may wish to have his loan spread across a number of borrowers (e.g., $5,000 for five borrowers each). The system receives these parameters and searches the database for potential borrowers that match (to at least some degree) the preferred parameters.

In some implementations, the lender is shown and may choose from specific borrowers and articles (e.g., selecting to finance a particular piece of jewellery at a certain store) whereas in other cases the matching is anonymous. In some cases, lenders may compete with each other to provide financing for particular borrowers and/or articles if the general belief is that the article will sell or the borrower is a known entity. In other cases, the borrowers may compete with each other to secure financing if the articles are not particularly desirable or of the credit history of the borrowers is less than ideal. The competitions may require borrows and/or lenders to alter their terms until a match (or matches) are found.

In some instances, the system may also facilitate insuring the loans through a central service. For example, in a hosted service implementation, the hosting entity may secure an insurance policy that names itself as the sole loss payee should any items be stolen, lost, or fraudulently entered, or if a borrower defaults on a loan. In such instances, the hosting entity, upon being notified of a loss, files a claim with the insurer, and in turn pays the lender the proceeds from the claim. The costs and overhead of securing and maintaining this insurance policy may be spread across all transactions and built into the fees and/or commissions charged by the hosting service. Such an arrangement eliminates the need to insure each item separately and maintain policies for each transaction, and is especially useful when a lender is financing multiple items held be different borrowers.

Unlike conventional micro-lending websites or lending auction websites where the lender's capital is secured by a promissory note, in this system the lender's capital is secured by specific, high-value articles that are traceable using RFID technology. Using the inventory control system described below, the borrowers can trace and track the location and movement of each piece, giving the lender immediate and continuous visibility into the particular article that secures his loan. Periodic reporting and messaging may also be used to alert the lender that the particular article has been moved, sold or otherwise changed hands. In some cases, lenders may be notified when an item is being moved (e.g., transferred from one retail location to another) and reject the transaction if, for example, the location to which the item is being moved has a higher risk due to greater theft. If an article is sold, the borrower may then return the capital of the loan, or, if preferred by the lender, the capital may be re-used to finance other articles for that borrower, or, in some case, other borrowers.

Lenders may, on occasion, decide they no longer wish to participate in the marketplace and do not want to continue to carry the loans. In such instances, the lender may place his loans “back in the marketplace” such that other lenders may assume the risks and potential returns associated with the loans. These loans may be discounted if the expected return is be lower than originally determined, or sold at a premium if, for example, the lender wants to lock in a known profit and eliminate any subsequent risk of loss. In some instances, a lender wishing to finance inventory may split his capital among new loans (i.e., items not yet financed) and existing loans placed back in the marketplace.

In these implementations, the system includes a central database for storing information related to the borrowers, lenders and the articles being financed. A communication server receives data from the stock computer(s) as well as providing web-based (or in some cases, WAP-enabled) pages to users of the system and email/text/SMS or other messaging services. An application server stores programming instructions that allocate and/or match lenders to borrowers based on a degree of match and/or other parameters described above.

In some implementations, the system (the communications server, database and application server) may be hosted by a third party service provider and made available to borrowers and lenders via the Internet. The service provider may, in some cases, collect fees for subscribing to the service, storing inventory data, matching borrowers and lenders, collecting and allocating payments, and providing periodic reports regarding the status of the loans and the inventory that secures the loans.

The invention may also be provided as an article of manufacture having a computer-readable medium with computer-readable instructions embodied thereon for performing the methods and implementing the systems described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM or downloaded from a server. The functionality of the techniques may be embedded on the computer-readable medium in any number of computer-readable instructions, or languages such as, for example, FORTRAN, PASCAL, C, C++, Java, C#, Tcl, Scala, Prolog, Scheme, Python, Perl, Ruby, BASIC and assembly language. Further, the computer-readable instructions may, for example, be written in a script, macro, or functionally embedded in commercially available software (such as, e.g., EXCEL or VISUAL BASIC.

What is claimed is:

1. A system for financing and tracking inventory, the system comprising:
a communications server for receiving:
(i) from one or more potential borrowers wishing to secure financing for items in inventory, information regarding the items in inventory and information regarding the potential borrowers;
(ii) from potential lenders wishing to provide financing for items in inventory, information regarding the potential lenders; and
(iii) from one or more inventory tracking sub-systems, information identifying one or more of the items in inventory;
a data storage module for storing the information received via the communication server and information collected by the inventory tracking sub-system; and
an application server comprising computer-executable programs stored on a computer readable medium, the programs providing instructions for:
(a) matching potential borrowers with potential lenders, thus identifying one or more selected lenders to provide financing to one or more selected borrowers;
(b) providing the selected lenders with electronic access, via the communications server, to the inventory information.

2. The system of claim 1 further comprising one or more inventory tracking subsystems.

3. The system of claim 2 wherein the inventory tracking subsystems comprise an RFID tracking system, and wherein each item of inventory is physically and securely tagged with an RFID tag.

4. The system of claim 3 wherein the RFID tags are tamper-evident.

5. The system of claim 1 wherein the communications server, data storage module and application server are hosted and operated as a service by an entity other than one of the borrowers or lenders.

6. The system of claim 5 wherein the inventory tracking sub-systems are each located at the premises of a borrower and the hosted service receives inventory information from the inventory tracking sub-systems via a network.

7. A method of financing inventory, the method comprising:
receiving, over an electronic network and at a communications server:
(i) a request from one or more potential borrowers wishing to secure financing for items in inventory held by the borrower wherein the request from the potential borrower comprises data describing the items in inventory held by the potential borrower and data describing the potential borrower;
(ii) a request from potential lenders wishing to provide financing for items in inventory wherein the request from the potential lenders comprises data describing potential borrower; and
(iii) information uniquely identifying one or more of the items in inventory being held by the borrower;
storing the information received via the communication server in a data storage device;
matching one or more of the potential borrowers with one or more of the potential lenders based at least in part on the stored information, thus identifying one or more selected lenders to provide financing to one or more selected borrowers for selected items held in inventory by the selected borrowers; and
providing the selected lenders with electronic access, via the communications server and the electronic network, to inventory information related to the selected items in inventory.

8. The method of claim 7 wherein the data describing the potential borrower comprises one or more of security information, credit history or desired financial terms.

9. The method of claim 7 wherein the data describing the potential lender comprises one or more of desired inventory items to be financed, financial terms or desired borrowers.

10. The method of claim 7 wherein the inventory information related to the selected items in inventory comprises an indication of the real-time location if the selected items.

11. The method of claim 7 wherein the inventory information related to the selected items in inventory comprises an indication of a change in the location of the selected items.
